(19) United States
(12) Patent Application Publication
(10) Pub. No.: US 2012/0183378 A1
(43) Pub. Date: Jul. 19, 2012

(54) Silo Having a Filling Device

(76) Inventor: Adolf Buchfink, Rosengarten (DE)

(21) Appl. No.: 13/497,162

(22) PCT Filed: Sep. 14, 2010
(86) PCT No.: PCT/EP2010/005624

§ 371 Date: Mar. 20, 2012

(30) Foreign Application Priority Data
Sep. 21, 2009 (DE) 10 2009 041 970.5

(51) Int. Cl. B65G 65/32

(52) U.S. Cl. 414/293

(57) ABSTRACT

A silo has a silo chamber enclosed by an outer wall. A filling pipe for feeding bulk goods is provided, wherein the filling pipe has a plurality of valve openings arranged at varying heights. The filling pipe is arranged in a feed chamber, which is separated from the silo chamber by a partition wall. The partition wall is provided with a plurality of outlet openings arranged at varying heights. Large silos can be filled without the segregation of the bulk goods.

### BACKGROUND

The invention relates to a silo comprising a silo compartment. A filler pipe for feeding in bulk material is arranged in the silo. The filler pipe comprises a plurality of valve openings arranged at different heights.

If a silo is filled such that the bulk material can fall into the silo compartment through a pipe opening in the roof of the silo, the falling bulk material flow induces an air movement in the silo compartment. The air is drawn downward with the bulk material flow and rises up again in a region remote from the bulk material flow. This air movement results in finer particles being separated from coarser particles in the bulk material. The finer particles are entrained by the airflow and are primarily deposited in those areas where the air rises up again. In the case of a silo, for example, in which the bulk material flow is fed in at the center, the finer particles concentrate in the vicinity of the outer wall. Such segregation of the bulk material is unwanted.

It is known practice for the silo to be provided with a filler pipe through which the bulk material is fed into the silo compartment. The filler pipe is provided in each instance with a plurality of openings which are arranged at different heights. The bulk material flow exits in each instance through the lowermost opening which is still above the filling level of the bulk material in the silo compartment. Each of the higher-up openings is closed off by a valve mechanism. The falling height between the lowermost opening and the bulk material in the silo compartment is small, with the result that no segregation of the bulk material takes place. Silos of this type are known both in an embodiment in which a plurality of filler pipes are arranged in the vicinity of the outer wall (WO00/51924A1) and in an embodiment with a central filler pipe (“An anti-segregation tube to counteract air current segregation”, by Are Dyroy and Gisle G. Enstad, pages 27 to 30, POSTEC Newsletter No. 16, December 1997). As silos become larger, the forces acting on the filler pipes during emptying are considerable. The filler pipes themselves or the valve mechanisms may become damaged.

### SUMMARY

A silo is provided in which it is possible even for large quantities of bulk material to be added and withdrawn without damaging the silo.

A filler pipe is arranged in a feed chamber which is separated from the silo compartment by a partition wall. A plurality of outlet openings arranged at different heights are provided in the partition wall.

First of all, a few terms will be explained. In a filler pipe the bulk material moves downward under the influence of gravity. The filler pipe is oriented vertically in many cases, but other embodiments are possible in which the filler pipe is inclined with respect to the vertical.

A valve opening denotes an opening in the filler pipe through which the bulk material exits from the filler pipe only when the bulk material in the filler pipe has banked up to the height of the relevant valve opening. A bulk material flow in motion passes by the valve opening without bulk material exiting. Banked-up bulk material is no longer capable of moving further downward and instead slides through the valve opening and out of the filler pipe.

When filling the silo, the bulk material passes at a given time either only through one valve opening of the filler pipe or through a plurality of valve openings which are arranged at approximately equal height. These active valve openings are situated directly above the filling level in the feed chamber. Lower-down valve openings are covered by the bulk material in the feed chamber. The bulk material does not exit through higher-up valve openings. The bulk material flow thus exits from the filler pipe exclusively through the active valve openings which are arranged only slightly above the filling level in the feed chamber. Therefore, the bulk material has only a small falling height in the feed chamber, whereby no segregation takes place.

The filling level in the feed chamber is dependent on the filling level in the silo compartment. The bulk material continues to slide from the feed chamber into the silo compartment through the outlet openings situated at the corresponding height until the filling level in the feed chamber is only slightly higher than the filling level in the silo compartment. Even as it passes from the feed chamber into the silo compartment, the bulk material thus has a small falling height, with the result that segregation is also avoided here.

Outlet openings are provided in the partition wall which encloses the feed chamber and separates the latter from the silo compartment. The outlet openings can have the form of simple perforations and be free of moving parts. The partition wall can therefore be designed in a problem-free manner such that it is sufficiently stable to withstand the forces which occur when emptying the silo.

In order for even large material flows to be able to be managed, the feed chamber is preferably provided with a plurality of filler pipes. The filler pipes can be arranged close to the partition wall. If the valve openings of the filler pipes are additionally oriented in a direction opposed to the partition wall, a uniform filling of the feed chamber thus becomes possible.

The valve openings can be provided with a valve mechanism such that the valve openings can adopt an opened and a closed state. In the opened state, bulk material can pass through the valve openings while, in the closed state, no bulk material passes through the valve openings. In the normal state, that is to say when no external forces are acting, the valve openings are preferably closed. This can be achieved for example by means of a flap which is suspended above the valve opening and is situated in front of the valve opening due to gravity. If a bulk material flow moves through the filler pipe and past the valve opening, a vacuum is generated which causes the valve to be closed even more firmly. If appropriate, a spring force which keeps the valve opening in the closed state may additionally be provided. At the height of the active valve openings, the bulk material flow cannot fall further downward. Instead, the bulk material exerts a laterally directed force onto the wall of the filler pipe. The valve opening is preferably designed such that it opens under the influence of this force, with the result that the bulk material can slide out of the filler pipe.

In an alternative embodiment, baffle plates which extend inwardly from the wall of the filler pipe are mounted above the valve openings. The baffle plates deflect the bulk material flow such that it is at a distance from the wall of the filler pipe when it passes by the valve opening. It is only when the bulk material has banked up to the height of the valve opening that it passes through the valve opening. This embodiment has the advantage that it dispenses with any moving parts.

To ensure that the falling height remains low during transit from the filler pipe into the feed chamber, the vertical spacing between the valve openings must be small. The spacing between the upper end of one valve opening and the lower end of the immediately higher valve opening is preferably less than 1 m, more preferably less than 0.5 m, more preferably still less than 0.3 m. If the valve openings are not arranged directly above one another but offset laterally with respect to one another, a height overlap is also possible. It is particularly possible with such an overlap for a plurality of valve openings to be active at the same time, with the bulk material thus exiting from the filler pipe through a plurality of active valve openings at the same time.

Even when the bulk material transits from the feed chamber into the silo compartment through the outlet openings, the falling height should be small. The same accordingly applies to the vertical spacing of the outlet openings relative to one another and to the spacing between the lowermost outlet opening and the bottom of the silo compartment. The lowermost valve opening is preferably arranged just above the lowermost outlet opening. It is advantageous for the stability of the construction if the partition wall and the filler pipe have a connection to the bottom of the silo. It is also possible for the filler pipe in particular to be open at its bottom. The outlet openings are preferably distributed over the circumference of the feed chamber such that the silo compartment is filled uniformly. For example, it is possible at one particular height for from 10 to 20 outlet openings to be distributed over the circumference of the feed chamber.

The silo should be designed in such a way that a constant bulk material flow from the filler pipe into the silo compartment via the feed chamber is achieved during filling without the bulk material banking up in one of the components. The filler pipe should therefore be designed such that the maximum possible bulk material flow in the filler pipe can exit through the active valve openings. The maximum bulk material flow through the active valve openings is preferably at least 10% greater than the maximum bulk material flow through the filler pipe. The maximum bulk material flow from the feed chamber into the silo compartment should in turn be large enough that it is also not possible for the bulk material to bank up in the feed chamber.

In the case of the silo, the silo compartment cannot be filled up to a uniform filling height. Rather, the filling level is highest in the vicinity of the feed chamber and becomes lower as the distance from the feed chamber increases. The inclination in the surface of the bulk material corresponds to the bulk material angle of the material. In the case of aluminum oxide for aluminum production, for which the silo according to the invention is particularly well suited, the bulk material angle is approximately 30°. The roof of the silo may be inclined to correspond to the bulk material angle of the material that is to be stored. The feed chamber is preferably arranged at a distance from the outer wall or arranged in the center of the silo such that the roof has its greatest height at that point and can slope downwardly toward the sides.

It is also possible for a plurality of feed chambers to be provided in the silo compartment. This may be particularly advantageous when an already existing silo having a small height but a large areal extent is retrofitted. With a single feed chamber, and as a result of the bulk material angle, such a silo could only be filled to a small extent.

The advantages of the silo apply particularly when large quantities of bulk material are to be stored or when large quantities of material are to be added or withdrawn within a short time. The volume of the silo is preferably greater than 10,000 m³, more preferably greater than 20,000 m³, more preferably still greater than 40,000 m³. The capacity of the silo for aluminum oxide is preferably between 10,000 t and 150,000 t. The diameter of the silo compartment is preferably greater than 40 m, more preferably greater than 60 m, more preferably still greater than 80 m. The bulk material flow for which the silo is designed can amount to 400 t/h, for example. In order to be able to manage this quantity, the individual filler pipe preferably has a diameter of more than 10 cm, more preferably of more than 20 cm, and the feed chamber has a diameter of more than 1 m, preferably more than 2 m.

### BRIEF DESCRIPTION OF THE DRAWINGS

The invention will be described by way of example below in terms of an advantageous embodiment with reference to the appended drawings, in which:

FIG. 1 shows a cross section through a silo;

FIG. 2 shows an enlarged detail from FIG. 1;

FIG. 3 shows a cross section through FIG. 2 along the line 3-3; and

FIG. 4 shows an embodiment of a filler pipe.

### DETAILED DESCRIPTION

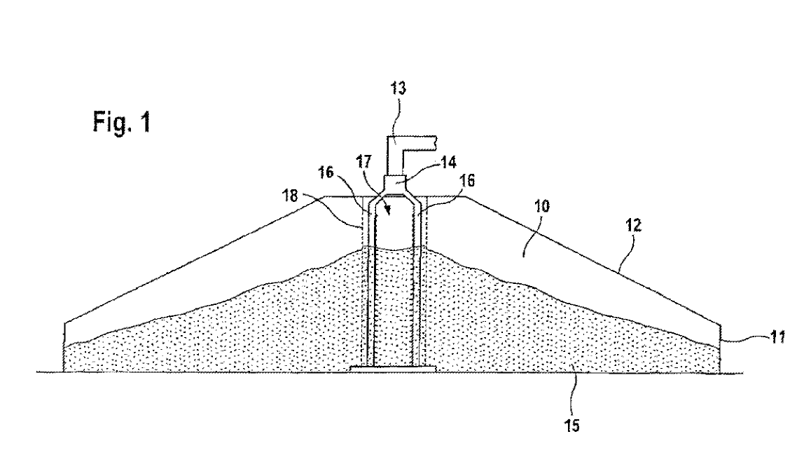

In the case of a silo as shown in FIG. 1 that is intended for the storage of aluminum oxide, a silo compartment 10 of circular cross section is enclosed by an outer wall 11. The silo compartment 10 has a diameter of 100 m. The outer wall is approximately 8 m high, with the height of the silo in its center being approximately 25 m. The silo thus has a capacity of more than 100,000 t of aluminum oxide when it is filled nearly up to the roof 12. FIG. 1 shows the silo filled to approximately 70% with aluminum oxide as bulk material 15, with the filling height decreasing from the center to the outer wall 11, commensurately with the bulk material angle of the material. The roof 12 of the silo has an inclination corresponding approximately to the bulk material angle of the material.

Further bulk material 15 is fed into the silo through a pipeline 13 opening in the silo. A distribution chamber 14 is used to distribute the bulk material 15 from the pipeline 13 to a plurality of filler pipes 16. From the filler pipes 16 the bulk material first passes into a feed chamber 17 which is separated from the silo compartment 10 by a partition wall 18. The bulk material 15 moves from the feed chamber 17 into the silo compartment 10 by passing through the partition wall 18. The feed chamber 17 may be designed to be self-supporting. Where appropriate, the feed chamber forms an additional support for the roof 12.

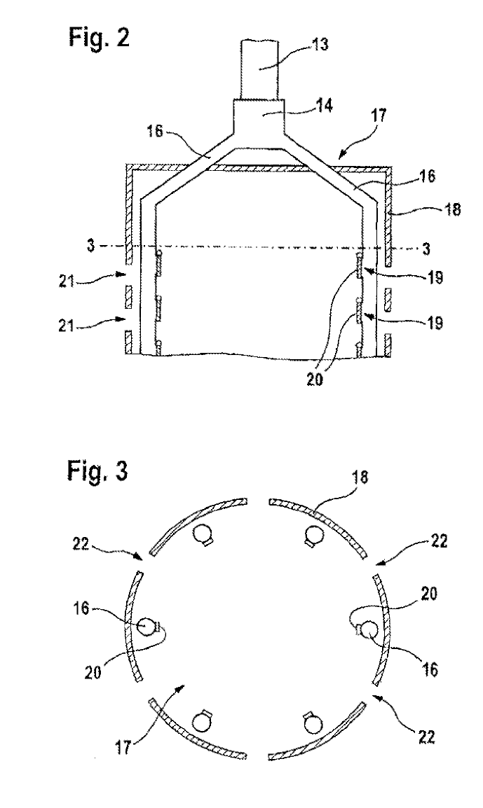

The upper portion of the feed chamber 17 is illustrated on an enlarged scale in FIG. 2. In each of the filler pipes 16, a plurality of valve openings 19 are formed one above the other. The valve openings 19 are each constituted by an opening in the wall of the filler pipe 16 that is closed by a flap 20. The flap 20 is hinge-mounted on the wall of the filler pipe 16 above the opening such that it hangs vertically downward under the influence of gravity and closes the opening in the wall of the filler pipe 16. Alternatively, a spring force acts on the flap 20, keeping the latter in the closed position.

The filler pipes are enclosed by the partition wall 18 which separates the feed chamber 17 from the silo compartment 10. As indicated by the double lines, the partition wall 18 is of stable design, with the result that the partition wall 18 can withstand the loads which occur in the silo. These loads are especially the shear forces when the bulk material 15 slides downward parallel to the partition wall 18, and compressive forces when the bulk material 15 in the silo compartment 10 moves in the transverse direction. The filler pipes 16, which would themselves not withstand this loading, are protected by the partition wall 18.

A plurality of outlet openings 21 are provided at different heights in the partition wall 18. The outlet openings 21 are simple perforations in the partition wall 18 that do not feature any moving parts. The outlet openings 21 are thus also formed in such a way that they are not adversely affected by the shear forces. In the cross-sectional illustration of FIG. 2, one outlet opening 21 corresponds to each valve opening 19. The outlet opening 21 is in each case arranged slightly lower than the valve opening 19 such that bulk material, which has entered the feed chamber 17 through one of the valve openings 19, can slide into the silo compartment 10 through the associated outlet opening 21. As FIG. 3 shows, further outlet openings 22 are formed at other circumferential positions between the filler pipes 16. The outlet openings 22 are arranged at a different height than the outlet openings 21; however, there is a height overlap in each case. For each filling level in the feed chamber 17, there are thus outlet openings 21, 22 in the partition wall 18 through which the bulk material can slide into the silo compartment 10. The feed chamber 17 is circular in cross section and has a diameter of approximately 2 m. The filler pipes 16 likewise have a circular cross section and a diameter of approximately 20 cm.

If the silo compartment 10 in the immediate vicinity of the feed chamber 17 has been filled with bulk material 15 to a certain filling height, the bulk material 15 thus continues to slide from the feed chamber 17 into the silo compartment 10 until the filling level in the feed chamber 17 is only a little higher than the filling level in the silo compartment 10. In order to allow further filling of the silo compartment 10, the feed chamber 17 must thus have at least a filling height corresponding to that in the silo compartment 10. Outlet openings 21, 22 in the partition wall 18 and valve openings 19 in the filler pipes 16 which are situated below this filling height are closed off by the bulk material 15. The higher-up outlet openings 21, 22 in the partition wall 18 are open and freely penetrable. The higher-up valve openings 19 in the filler pipes 16 are closed by the flaps 20 in the normal state. If further bulk material is now fed through the pipeline 13 and the distribution chamber 14 to the filler pipes 16, the filler pipes 16 first fill to a filling level corresponding to that of the feed chamber 17. If the filling level in the filler pipes 16 rises further, the column of bulk material 15 exerts a laterally directed force by means of which the flap 20 of the immediately higher valve opening 19 is pressed laterally such that this valve opening 19 opens and thus changes into the active state. The bulk material 15 can slide through the active valve opening 19 into the feed chamber 17. There occurs a constant bulk material flow from the distribution chamber 17 via the filler pipes 16 and the active valve openings 19 into the feed chamber 17. The bulk material flow generates a vacuum in the filler pipes 16 which keeps closed the valve openings 19 past which the bulk material flow passes.

If the bulk material flow causes the filling level in the silo compartment 10, and hence also the filling level in the feed chamber 17, to rise, the active valve opening 19 is covered and closed by the bulk material in the feed chamber 17. It is not possible for any further bulk material 15 to exit through this valve opening 19, and the valve opening 19 becomes inactive. Consequently, the filling level in the filler pipe 16 rises and the immediately higher valve opening 19 becomes activated.

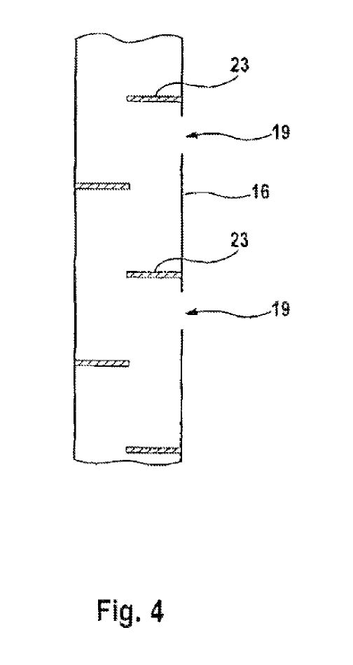

In the embodiment of FIG. 4, the valve openings 19 are configured as simple perforations in the wall of the filler pipe 16. Baffle plates 23 are mounted above the valve openings 19. A bulk material flow falling through the filler pipe 16 is diverted by the respective baffle plate 23 in such a way that said flow maintains a distance from the relevant valve opening 19 therefore does not exit through the valve opening 19. It is only when the bulk material 15 in the filler pipe 16 has banked up to the height of the valve opening 19 that the bulk material 15 slides through the valve opening 19 into the feed chamber 17.

The vertical spacing between two adjacent valve openings 19 is approximately 30 cm. The maximum falling height to which the bulk material 15 is subject when passing from the filler pipes 16 into the feed chamber 17 is thus small. There is a height overlap between the outlet openings 21, 22 in the partition wall 18, with the result that the falling height of the bulk material 15 when it passes from the feed chamber 17 into the silo compartment 10 is virtually zero. The bulk material 15 is thus channeled by the filler pipes 16 into the silo compartment 10 via the feed chamber 17 without the bulk material 15 being subject to a significant falling height. No segregation of the bulk material 15 takes place.

1. A silo comprising a silo compartment and a filler pipe for feeding in bulk material, wherein the filler pipe comprises a plurality of valve openings arranged at different heights, characterized in that the filler pipe is arranged in a feed chamber which is separated from the silo compartment by a partition wall, and in that a plurality of outlet openings, arranged at different heights are provided in the partition wall.

2. The silo as claimed in claim 1, characterized in that a plurality of filler pipes are provided in the feed chamber.

3. The silo as claimed in claim 2, characterized in that the filler pipes are arranged close to the partition wall and in that the valve openings are oriented in a direction opposed to the partition wall.

4. The silo as claimed in claim 1, characterized in that the valve openings comprise a valve mechanism.

5. The silo as claimed in claim 4, characterized in that the valve openings are closed in a normal state.

6. The silo as claimed in claim 4, characterized in that the valve openings are held in the closed state by means of spring force.

7. The silo as claimed in claim 1, characterized in that baffle plates which extend inwardly from a wall of the filler pipe are arranged above the valve openings.

8. The silo as claimed in claim 1, characterized in that a plurality of valve openings are active valve openings and the maximum bulk material flow through the active valve openings at a first maximum rate and the bulk material flows through the filler pipes at a second maximum rate less than the first maximum rate.

9. The silo as claimed in claim 1, characterized in that two adjacent valve openings have a vertical spacing is less than 1 m.

10. The silo as claimed in claim 1, characterized in that the feed chamber is situated at a distance from an outer wall of the silo compartment.

11. The silo as claimed in claim 1, characterized in that the silo compartment has a volume greater than 10,000 m³.

12. The silo as claimed in claim 1, characterized in that the silo compartment has its greatest height in a region of the feed chamber.

13. The silo as claimed in claim 1, characterized in that a plurality of feed chambers are provided in the silo compartment.

14. The silo as claimed in claim 9, characterized in that two adjacent valve openings have a vertical spacing less than 50 cm.

15. The silo as claimed in claim 14, characterized in that the vertical spacing between two adjacent valve openings is less than 30 cm.

16. The silo as claimed in claim 11, characterized in that the volume is greater than 20,000 m³.

17. The silo as claimed in claim 11, characterized in that the volume is greater than 40,000 m³.

18. The silo as claimed in claim 2, characterized in that the valve openings comprise a valve mechanism.

19. The silo as claimed in claim 3, characterized in that the valve openings comprise a valve mechanism.

20. The silo as claimed in claim 5, characterized in that the valve openings are held in the closed state by means of spring force.
